(19) United States
(12) Patent Application Publication
(10) Pub. No.: US 2022/0238892 A1
(43) Pub. Date: Jul. 28, 2022

(54) METHOD FOR PRODUCING ALLOY FINE PARTICLE-SUPPORTED CATALYST, ELECTRODE, FUEL CELL, METHOD FOR PRODUCING ALLOY FINE PARTICLE, ALLOY FINE PARTICLE-SUPPORTED CATALYST, ALLOY FINE PARTICLE, METHOD FOR PRODUCING MEMBRANE ELECTRODE ASSEMBLY, AND METHOD FOR PRODUCING FUEL CELL

(71) Applicant: TOYOTA BOSHOKU KABUSHIKI KAISHA, Aichi (JP)

(72) Inventors: Hiroshi YANO, Aichi (JP); Kota IWASAKI, Aichi (JP)

(73) Assignee: TOYOTA BOSHOKU KABUSHIKI KAISHA, Aichi (JP)

(21) Appl. No.: 17/583,331

(22) Filed: Jan. 25, 2022

(30) Foreign Application Priority Data
Jan. 27, 2021 (JP) 2021-010750

(51) Int. Cl. H01M 4/92; H01M 8/1004; H01M 4/88; H01M 8/10

(52) U.S. Cl. CPC H01M 4/926; H01M 4/921; H01M 2008/1095; H01M 4/8882; H01M 8/1004

(57) ABSTRACT

A method for producing an alloy fine particle-supported catalyst that supports alloy fine particles containing a noble metal includes: a step of mixing a noble metal salt, a base metal salt, an alcohol having 1 to 5 carbon atoms, and a support to form a mixture; and a heating step of heating the mixture at a temperature of 150° C. or higher and 800° C. or lower to produce an alloy fine particle-supported catalyst.

### BACKGROUND OF THE INVENTION

### 1. Field of the Invention

The present disclosure relates to a method for producing an alloy fine particle-supported catalyst, an electrode, a fuel cell, a method for producing alloy fine particles, an alloy fine particle-supported catalyst, an alloy fine particle, a method for producing a membrane electrode assembly, and a method for producing a fuel cell.

This application is based on Japanese Patent Application No. 2021-010750 filed on Jan. 27, 2021 and claims the benefit of the priority thereof, the entire content of which is incorporated herein by reference.

### 2. Description of Related Art

Active metal-supported catalysts are applied in sensors, petroleum refining, hydrogen production, and other fields such as environment-related fields and energy fields. Among them, a fuel cell, which has been researched and developed in recent years as a power source for automobiles and stationary cogeneration, is given as a typical example.

Under such circumstances, methods for producing a catalyst have been studied in JP 2010-253408 A (Patent Document 1), JP 2001-224968 A (Patent Document 2), JP 2015-17317 A (Patent Document 3), JP 2018-44245 A (Patent Document 4), and JP 2009-164142 A.

In addition, alloys of a noble metal such as Pt have been studied in JP 2002-95969 A, JP 2007-27096 A, JP 2009-263719 A, JP 2019-30846 A, JP 2009-218196 A, JP 2012-38543 A, T. Toda, H. Igarashi, H. Uchida and M. Watanabe, J. Electrochem. Soc., 146, 3750 (1999), and N. Wakabayashi, M. Takeichi, M. Itagaki, H. Uchida and M. Watanabe, J. Phys. Chem. B, 109, 5836 (2005).

### SUMMARY OF THE INVENTION

In the techniques of the above-indicated documents, the production of the catalyst may not be necessarily simple.

In addition, in the techniques of the above-indicated documents, the catalyst may not necessarily have sufficient performance.

The present disclosure has been made for solving at least a part of the above problems, and can be realized in the following forms.

A method for producing an alloy fine particle-supported catalyst that supports alloy fine particles containing a noble metal, the method including:

a step of mixing a noble metal salt, a base metal salt, an alcohol having 1 to 5 carbon atoms, and a support to form a mixture; and

a heating step of heating the mixture at a temperature of 150° C. or higher and 800° C. or lower to produce an alloy fine particle-supported catalyst.

According to the production method, a highly active alloy fine particle-supported catalyst can be produced by a simplified method.

### BRIEF DESCRIPTION OF THE DRAWINGS

FIG. 1 is an explanatory diagram showing a comparison between the number of synthesis steps in Examples and the number of steps in each of the patent documents;

FIG. 2 is a view showing TEM images and particle diameter distributions of PtₓCo/C;

FIG. 3 is a view showing TEM images, particle diameter distributions, and composition analysis values of Pt_{X}V/C;

FIG. 4 is a view showing TEM images and particle diameter distributions of Pt₃Ni/C;

FIG. 5 is a view showing TEM images and particle diameter distributions of Pt₃Co/C and Pt/C;

FIG. 6 is a view showing electrochemical characteristics of Pt₃Co/C;

FIG. 7 is a view for comparison in activity of an oxygen reduction reaction (ORR);

FIG. 8 is a view for comparison in H₂O₂ generation rate; and

FIG. 9 is a schematic diagram of an example of a polymer electrolyte fuel cell.

### DETAILED DESCRIPTION OF PREFERRED EMBODIMENTS

Here, other examples of the present disclosure are presented.

2. The method for producing an alloy fine particle-supported catalyst, wherein a total concentration of the noble metal salt and the base metal salt in an alcohol solution in which the noble metal salt and the base metal salt are dissolved is 2 mol L⁻¹ or more and 100 mol L⁻¹ or less.

According to the production method, an alloy fine particle-supported catalyst having a small particle diameter and high activity can be produced.

3. The method for producing an alloy fine particle-supported catalyst, wherein an average particle diameter of the alloy fine particles is 0.7 nm or more and less than 2 nm.

According to the production method, an alloy fine particle-supported catalyst having a small particle diameter and high activity can be produced.

4. An electrode containing the alloy fine particle-supported catalyst produced by the production method.

The electrode has high performance because it contains an alloy fine particle-supported catalyst having a small particle diameter and high activity.

5. A fuel cell containing the alloy fine particle-supported catalyst produced by the production method.

The fuel cell has high performance because it contains an alloy fine particle-supported catalyst having a small particle diameter and high activity.

6. A method for producing alloy fine particles, including:

a step of mixing a noble metal salt, a base metal salt, and an alcohol having 1 to 5 carbon atoms to form a mixture; and

a heating step of heating the mixture at a temperature of 150° C. or higher and 800° C. or lower to produce alloy fine particles containing a noble metal.

According to the production method, highly active alloy fine particles can be produced by a simplified method.

7. The method for producing alloy fine particles, wherein a total concentration of the noble metal salt and the base metal salt in an alcohol solution in which the noble metal salt and the base metal salt are dissolved is 2 mol L⁻¹ or more and 100 mol L⁻¹ or less.

According to the production method, alloy fine particles having a small particle diameter and high activity can be produced.

8. The method for producing alloy fine particles, wherein an average particle diameter of the alloy fine particles is 0.7 nm or more and less than 2 nm.

According to the production method, alloy fine particles having a small particle diameter and high activity can be produced.

9. An electrode containing the alloy fine particles produced by the production method.

The electrode has high performance because it contains alloy fine particles having a small particle diameter and high activity.

10. A fuel cell containing the alloy fine particles produced by the production method.

The fuel cell has high performance because it contains alloy fine particles having a small particle diameter and high activity.

11. An alloy fine particle-supported catalyst in which alloy fine particles containing a noble metal are supported on a support, wherein an average particle diameter of the alloy fine particles is 0.7 nm or more and less than 2 nm.

The alloy fine particle-supported catalyst has high activity.

12. An electrode containing the alloy fine particle-supported catalyst.

The electrode has high performance because it contains a highly active alloy fine particle-supported catalyst.

13. A fuel cell containing the alloy fine particle-supported catalyst.

The fuel cell has high performance because it contains a highly active alloy fine particle-supported catalyst.

14. An alloy fine particle having an average particle diameter of 0.7 nm or more and less than 2 nm and containing a noble metal.

The alloy fine particle has high activity.

15. An electrode containing the alloy fine particles.

The electrode has high performance because it contains highly active alloy fine particles.

16. A fuel cell containing the alloy fine particles.

The fuel cell has high performance because it contains highly active alloy fine particles.

17. A method for producing a membrane electrode assembly having an electrolyte membrane and an electrode, the method including:

a step of spraying a mixture obtained by mixing a noble metal salt, a base metal salt, at least one solvent selected from alcohols having 1 or more and 5 or less carbon atoms, and a support onto the electrolyte membrane and drying the mixture to form alloy fine particles containing a noble metal, thereby forming the electrode containing the alloy fine particles on a surface of the electrolyte membrane.

According to the production method, a membrane electrode assembly can be produced by a simplified method. Conventionally, a catalyst prepared in advance is sprayed onto an electrolyte membrane to form a membrane electrode assembly. That is, the conventional method requires a catalyst production step and a catalyst layer (electrode) formation step. According to the production method of the present disclosure, the step of spraying a mixture onto an electrolyte membrane and drying the mixture also serves as both the catalyst production step and the catalyst layer (electrode) formation step, and thus a membrane electrode assembly can be produced through fewer steps.

18. A method for producing a fuel cell containing a membrane electrode assembly having an electrolyte membrane and an electrode, the method including:

a step of spraying a mixture obtained by mixing a noble metal salt, a base metal salt, at least one solvent selected from alcohols having 1 or more and 5 or less carbon atoms, and a support onto the electrolyte membrane and drying the mixture to form alloy fine particles containing a noble metal, thereby forming the electrode containing the alloy fine particles on a surface of the electrolyte membrane.

According to the production method, a fuel cell can be produced by a simplified method. Conventionally, a catalyst prepared in advance is sprayed onto an electrolyte membrane to form a catalyst layer (electrode). That is, the conventional method requires a catalyst production step and a catalyst layer (electrode) formation step. According to the production method of the present disclosure, the step of spraying a mixture onto an electrolyte membrane and drying the mixture also serves as both the catalyst production step and the catalyst layer (electrode) formation step, and thus a fuel cell can be produced through fewer steps.

Hereinafter, embodiments of the present disclosure will be described in detail. In the present specification, a phrase about a numerical range using the word “to” includes a lower limit value and an upper limit value unless otherwise specified. For example, the phrase “10 to 20” includes both the lower limit “10” and the upper limit “20”. That is, the phrase “10 to 20” has the same meaning as “10 or more and 20 or less”.

As a result of intensive studies, the present inventors have found the following facts. As a performance index of a nanoparticle-shaped electrode catalyst, mass activity per gram of Pt (MA [A gPt⁻¹]) is generally used. MA is expressed by a product of a specific activity (j [A m⁻²]) and an electro active surface area (ECA [m² gPt⁻¹]) (MA [A gPt⁻¹]=j [A m⁻²]×ECA [m² gPt⁻¹]). That is, in order to improve the catalytic performance, it is necessary to improve two factors, j and ECA. The present inventors have found that the ECA value is increased by accurately controlling the particle diameter of catalyst particles within a predetermined range and making their size uniform, so that MA can be improved. In addition, the present inventors have found that the mass activity can be efficiently enhanced by improving the j value through alloying.

Alloying Pt with a second component metal element such as a base metal (non-noble metal) is most effective for improving the specific activity (j). This is presumed to be due to an electron modification effect from a base alloy (core) to a Pt skin layer (shell) spontaneously formed by elution of the second component metal element from the alloy surface, and dissolution and reprecipitation of Pt during a potential cycle. Important factors for maximizing the electron modification effect are: [first factor] to make the particle diameter (particle size distribution) uniform; and [second factor] to control the metal composition. Furthermore, another important factor is: [third factor] to form fine particles (for example, particles of 2 nm or less). However, an alloy synthesis method satisfying these three factors has not been disclosed or suggested in the prior art. When neither the [first factor] nor the [second factor] is satisfied, the alloy catalyst is physically affected by, for example, a temperature atmosphere or a potential fluctuation during system operation, and dealloying is likely to occur. It has been found that, as a result, the performance is deteriorated to the same level as that of Pt alone. Furthermore, the dealloyed second element and oxygen react with H₂O₂ generated through a side reaction of the oxygen reduction reaction to generate OH radicals. For example, in a polymer electrolyte fuel cell, an electrolyte membrane is decomposed due to OH radicals, so that the cell performance may be deteriorated. Under such a background, the inventors have developed a technique that improves uniformity of the particle diameter, enables combination of desired metal compositions, and enables preparation of alloy fine particles (Pt alloy nanoparticles) stable against dealloying. The inventors have found that this technique can further maintain the alloy effect to suppress the generation of H₂O₂, and can solve various conventional problems.

The technique of the present disclosure is based on the above idea unique to the present inventors.

### 1. Method for Producing Alloy Fine Particle-Supported Catalyst

The method for producing an alloy fine particle-supported catalyst of the present disclosure is a method for producing an alloy fine particle-supported catalyst that supports alloy fine particles containing a noble metal. The method for producing an alloy fine particle-supported catalyst of the present disclosure includes: a step of mixing a noble metal salt, a base metal salt, an alcohol having 1 to 5 carbon atoms, and a support to form a mixture; and a heating step of heating the mixture at a temperature of 150° C. or higher and 800° C. or lower to produce an alloy fine particle-supported catalyst.

### (1) Alloy Fine Particles

The alloy contains a noble metal. The noble metal is not particularly limited. The noble metal used is preferably at least one selected from the group consisting of platinum (Pt), palladium (Pd), rhodium (Rh), gold (Au), silver (Ag), iridium (Ir), and ruthenium (Ru). Among these noble metals, at least one selected from the group consisting of Pt, Rh, Pd, Ir, and Ru is more preferred, and at least one selected from the group consisting of Pt and Pd is further preferred, from the viewpoint of catalytic performance.

The alloy contains a base metal. The base metal is not particularly limited. The base metal is preferably at least one selected from the group consisting of cobalt, vanadium, nickel, iron, manganese, chromium, titanium, niobium, molybdenum, lead, and tungsten. From the viewpoint of making the catalyst highly active, the base metal is preferably at least one selected from the group consisting of cobalt, vanadium, and nickel.

Examples of the alloy include Pt_{X}Co (x=0.5 to 9), Pt_{X}V (x=0.5 to 9), and Pt_{X}Ni (x=0.5 to 9). Pt_{X}Co (x=1 to 3), Pt_{X}V (x=1 to 3), and Pt_{X}Ni (x=1 to 3) are preferably exemplified.

### (2) Noble Metal Salt

The noble metal contained in the noble metal salt is not particularly limited. The noble metal used is preferably at least one selected from the group consisting of platinum (Pt), palladium (Pd), rhodium (Rh), gold (Au), silver (Ag), iridium (Ir), and ruthenium (Ru). Among these noble metals, at least one selected from the group consisting of Pt, Rh, Pd, Ir, and Ru is more preferred, and at least one selected from the group consisting of Pt and Pd is further preferred, from the viewpoint of catalytic performance.

As the noble metal salt, at least one selected from the group consisting of hexachloroplatinum (IV) acid hexahydrate (H₂PtCl₆.6H₂O), tetraamminedichloroplatinum (Pt(NH₃)₄Cl₂.xH₂O), platinum bromide (IV) (PtBr₄), and bis(acetylacetonato)platinum (II) ([Pt(C₅H₇O₂)₂]) can preferably be used.

### (3) Base Metal Salt

The base metal contained in the base metal salt is not particularly limited. The base metal is preferably at least one selected from the group consisting of cobalt, vanadium, nickel, iron, manganese, chromium, titanium, niobium, molybdenum, lead, and tungsten. From the viewpoint of making the catalyst highly active, the base metal is preferably at least one selected from the group consisting of cobalt, vanadium, and nickel.

As the base metal salt, at least one selected from the group consisting of cobalt (II) chloride hexahydrate (CoCl₂.6H₂O), cobalt (II) nitrate hexahydrate (Co(NO₃)₂.6H₂O), vanadyl acetylacetonate (VO(acac)₂), nickel (II) chloride hexahydrate (CoCl₂.6H₂O), nickel (II) nitrate hexahydrate (Ni(NO₃)₂.6H₂O), and nickel (II) acetate tetrahydrate (Ni(CH₃COO)₂.4H₂O) can be suitably used.

### (4) Alcohol Having 1 to 5 Carbon Atoms

As the alcohol having 1 to 5 carbon atoms, at least one selected from the group consisting of methanol, ethanol, propanol, isopropyl alcohol, 1-butanol, 2-butanol, t-butyl alcohol, 1-pentanol, and 3-pentanol can preferably be used. Among these alcohols, ethanol is preferred from the viewpoint of reducing the environmental load.

An amount ratio between the alcohol and the metal salt (noble metal salt and base metal salt) is not particularly limited. A total concentration of the noble metal salt and the base metal salt in an alcohol solution in which the noble metal salt and the base metal salt are dissolved is not particularly limited. The total concentration of the noble metal salt and the base metal salt is preferably 2 mol L⁻¹ or more and 100 mol L⁻¹ or less, more preferably 5 mol L⁻¹ or more and 70 mol L⁻¹ or less, and further preferably 10 mol L⁻¹ or more and 60 mol L⁻¹ or less, from the viewpoint of producing highly active alloy fine particles having a particle diameter of 0.7 nm to 2 nm and a uniform size. A concentration ratio between the noble metal salt and the base metal salt is not particularly limited. The concentration ratio (molar ratio) of noble metal salt to base metal salt is preferably 3.3:1.0 to 0.9:1.0, and more preferably 3.0:1.0 to 1.0:1.0.

### (5) Support

The support is not particularly limited as long as it can support the alloy fine particles. As the support, at least one selected from carbon black, amorphous carbon, carbon nanotubes, carbon nanohorns, and one or more metal oxides selected from rare earths, alkaline earths, transition metals, niobium, bismuth, tin, antimony, zirconium, molybdenum, indium, tantalum, and tungsten can preferably be used. Among these supports, carbon black is preferred from the viewpoint of surface area.

When carbon black is used as the support, a nitrogen adsorption specific surface area of carbon black is not particularly limited. The nitrogen adsorption specific surface area of carbon black is preferably 10 m² g⁻¹ or more and 1800 m² g⁻¹ or less, and more preferably 150 m² g⁻¹ or more and 800 m² g⁻¹ or less, from the viewpoint of supporting the alloy fine particles.

### (6) Mixing Ratio of Support to Alcohol

A mixing ratio of the support to the alcohol is not particularly limited. From the viewpoint of fully blending the support and the alcohol into highly active alloy fine particles having a particle diameter of 0.7 nm to 2 nm and a uniform size, the support is preferably mixed at a ratio of 2 mg or more and 200 mg or less, more preferably mixed at a ratio of 10 mg or more and 100 mg or less, and further preferably mixed at a ratio of 30 mg or more and 80 mg or less, per mL of the alcohol.

### (7) Mixing

A mixing method is not particularly limited. Pulverization mixing may be performed using a mortar and a pestle. For example, pulverization mixing may be performed using a dry crusher such as a ball mill, a vibration mill, a hammer mill, a roll mill, or a jet mill. For example, mixing may be performed using a mixer such as a ribbon blender, a Henschel mixer, or a V-type blender.

A mixing time is not particularly limited. Mixing is preferably performed until the alcohol volatilizes so that the mixture dries.

### (8) Heating

A heating temperature is 150° C. or higher and 800° C. or lower, preferably 150° C. or higher and 400° C. or lower, and more preferably 150° C. or higher and 250° C. or lower, from the viewpoint of producing highly active alloy fine particles having a particle diameter of 0.7 nm to 2 nm and a uniform size.

Heating is preferably performed in an atmosphere of an inert gas. As the inert gas, a rare gas such as argon gas or nitrogen gas can preferably be used. Heating may be performed in air.

### (9) Average Particle Diameter of Alloy Fine Particles

The average particle diameter of the alloy fine particles is not particularly limited. The average particle diameter of the alloy fine particles is preferably 0.7 nm or more and less than 2 nm, and more preferably 1.0 nm or more and 1.6 nm or less, from the viewpoint of increasing the activity.

The average particle diameter can be determined by the following method (way to determine the average particle diameter). A synthesized catalyst is observed by a transmission electron microscope (TEM). A TEM photograph is printed out on paper. The alloy fine particles (black circular images) are regarded as spherical, and the length from end to end of each of the alloy fine particles is regarded as diameter. A total of 300 particles are randomly measured from images of several fields of view (3 to 5 fields of view). The average of the diameters of the counted 300 particles is defined as average particle diameter.

Further, the alloy fine particles preferably have a standard deviation value of 0% or more and 20% or less with respect to the average particle diameter value. The standard deviation value is calculated by creating a distribution map from the diameters of the 300 particles.

### (10) Effect of Production Method of the Present Embodiment

The production method of the present embodiment is a production method which enables production of an ultrafine and highly active supported catalyst by a very simple technique of mixing a noble metal salt, a base metal salt, and a support material in a highly volatile alcohol (for example, ethanol) and heat-treating the mixture, and which is environment-friendly because it does not generate any waste liquid in the producing process.

Further, the production method of the present embodiment can be used to produce an alloy fine particle-supported catalyst in which a highly active alloy composed of nano-level structures whose particle diameter can be controlled within the range of 0.7 nm to 2 nm extremely accurately only by the concentrations of the noble metal salt and the base metal salt and which have a uniform size, is highly dispersed and supported on a support such as carbon. This alloy fine particle-supported catalyst is extremely useful as an electrode catalyst.

Further, since the active metal has a particle diameter of less than 2 nm and is highly dispersed and supported on the support in the alloy fine particle-supported catalyst produced by the production method of the present embodiment, the metal utilization rate is high at the atomic level, and high performance is achieved. Therefore, for example, the alloy fine particle-supported catalyst is suitable, for example, as an electrode catalyst for a polymer electrolyte fuel cell used as a power source for households or automobiles for which reduction in the amount of noble metal used is required. The catalyst exhibits 10 times higher activity than that of a conventional product (Pt/C catalyst in which Pt nanoparticles of about 3 nm are supported on carbon). Furthermore, the alloy fine particle-supported catalyst can suppress the generation of hydrogen peroxide, which is a side reaction of the oxygen reduction reaction, to half or less of the conventional generation level.

### 2. Electrode

The electrode containing the alloy fine particle-supported catalyst may be used as a cathode, as an anode, or both as a cathode and as an anode.

### 3. Fuel Cell

The fuel cell contains the alloy fine particle-supported catalyst. Examples of the fuel cell can include a polymer electrolyte fuel cell (PEFC), a phosphoric acid fuel cell (PAFC), a molten carbonate fuel cell (MCFC), a solid oxide fuel cell (SOFC), an alkaline electrolyte fuel cell (AFC), and a direct fuel cell (DFC).

### 4. Method for Producing Alloy Fine Particles

The method for producing alloy fine particles of the present disclosure includes:

a step of mixing a noble metal salt, a base metal salt, and an alcohol having 1 to 5 carbon atoms to form a mixture; and

a heating step of heating the mixture at a temperature of 150° C. or higher and 800° C. or lower to produce alloy fine particles containing a noble metal.

### (1) Incorporation of Explanation

The above descriptions of “(1) Alloy fine particles”, “(2) Noble metal salt”, “(3) Base metal salt”, “(4) Alcohol having 1 to 5 carbon atoms”, “(7) Mixing”, “(8) Heating”, and “(9) Average particle diameter of alloy fine particles” described in the section “1. Methods for producing alloy fine particle-supported catalyst” are applied to the method for producing alloy fine particles of the present disclosure as they are, and these descriptions are omitted.

### (2) Effect of Production Method of the Present Embodiment

The production method of the present embodiment is a production method which enables production of ultrafine and highly active alloy fine particles by a very simple technique of mixing a noble metal salt and a base metal salt in a highly volatile alcohol (for example, ethanol) and heat-treating the mixture, and which is environment-friendly because it does not generate any waste liquid in the producing process.

Further, the production method of the present embodiment can be used to produce highly active alloy fine particles composed of nano-level structures whose particle diameter can be controlled within the range of 0.7 nm to 2 nm extremely accurately only by the concentrations of the noble metal salt and the base metal salt and which have a uniform size. These alloy fine particles are extremely useful in an electrode catalyst.

Further, since the active metal has a particle diameter of less than 2 nm in the alloy fine particles produced by the production method of the present embodiment, the metal utilization rate is high at the atomic level, and high performance is achieved. Therefore, for example, the alloy fine particles are suitable, for example, for an electrode catalyst for a polymer electrolyte fuel cell used as a power source for households or automobiles for which reduction in the amount of noble metal used is required. The catalyst exhibits 10 times higher activity than that of a conventional product (Pt/C catalyst in which Pt nanoparticles of about 3 nm are supported on carbon). Furthermore, the alloy fine particles can suppress the generation of hydrogen peroxide, which is a side reaction of the oxygen reduction reaction, to half or less of the conventional generation level.

### 5. Electrode

The electrode containing the alloy fine particles may be used as a cathode, as an anode, or both as a cathode and as an anode.

### 6. Fuel Cell

The fuel cell contains the alloy fine particles. Examples of the fuel cell can include a polymer electrolyte fuel cell (PEFC), a phosphoric acid fuel cell (PAFC), a molten carbonate fuel cell (MCFC), a solid oxide fuel cell (SOFC), an alkaline electrolyte fuel cell (AFC), and a direct fuel cell (DFC).

### 7. Alloy Fine Particle-Supported Catalyst

In the alloy fine particle-supported catalyst of the present disclosure, alloy fine particles containing a noble metal are supported on a support. The average particle diameter of the alloy fine particles is 0.7 nm or more and less than 2 nm. The alloy fine particle-supported catalyst can be produced by the above “1. Method for producing alloy fine particle-supported catalyst”.

### (1) Incorporation of Explanation

The above descriptions of “(1) Alloy fine particles”, “noble metal” in “(2) Noble metal salt”, “(5) Support”, and the way to determine the average diameter in “(9) Average particle diameter of alloy fine particles” described in the section “1. Methods for producing alloy fine particle-supported catalyst” are applied to the alloy fine particle-supported catalyst of the present disclosure as they are, and these descriptions are omitted.

### (2) Amount of Alloy Supported

The amount of the alloy supported is not particularly limited, and a required amount of the alloy may appropriately be supported in response to the target design and the like. From the viewpoint of catalytic performance and cost, the amount of the alloy supported is preferably 5 parts by mass or more and 70 parts by mass or less, and more preferably 10 parts by mass or more and 50 parts by mass or less, in terms of metal, per 100 parts by mass of the support.

### (3) Effect of Alloy Fine Particle-Supported Catalyst of the Present Embodiment

The alloy fine particle-supported catalyst of the present embodiment can be produced by a very simple technique of mixing a noble metal salt, a base metal salt, and a support material in a highly volatile alcohol (for example, ethanol) and heat-treating the mixture, and can also be produced by an environment-friendly production method which does not generate any waste liquid in the producing process.

Since the alloy fine particle-supported catalyst of the present embodiment has an average particle diameter of 0.7 nm or more and less than 2 nm, the metal utilization rate is high at the atomic level, and high performance is achieved. Therefore, for example, the alloy fine particle-supported catalyst is suitable, for example, as an electrode catalyst for a polymer electrolyte fuel cell used as a power source for households or automobiles for which reduction in the amount of noble metal used is required. The catalyst exhibits 10 times higher activity than that of a conventional product (Pt/C catalyst in which Pt nanoparticles of about 3 nm are supported on carbon). Furthermore, the alloy fine particle-supported catalyst can suppress the generation of hydrogen peroxide, which is a side reaction of the oxygen reduction reaction, to half or less of the conventional generation level.

### 8. Electrode

The electrode containing the alloy fine particle-supported catalyst may be used as a cathode, as an anode, or both as a cathode and as an anode.

### 9. Fuel Cell

The fuel cell contains the alloy fine particle-supported catalyst. Examples of the fuel cell can include a polymer electrolyte fuel cell (PEFC), a phosphoric acid fuel cell (PAFC), a molten carbonate fuel cell (MCFC), a solid oxide fuel cell (SOFC), an alkaline electrolyte fuel cell (AFC), and a direct fuel cell (DFC).

### 10. Alloy Fine Particles

The alloy fine particles of the present disclosure have an average particle diameter of 0.7 nm or more and less than 2 nm and contain a noble metal. The alloy fine particles can be produced by the above “4. Method for producing alloy fine particles” described above.

### (1) Incorporation of Explanation

The above descriptions of “(1) Alloy fine particles”, “noble metal” in “(2) Noble metal salt”, and the way to determine the average diameter in “(9) Average particle diameter of alloy fine particles” described in the section “1. Methods for producing alloy fine particle-supported catalyst” are applied to the alloy fine particles of the present disclosure as they are, and these descriptions are omitted.

### (2) Effect of Alloy Fine Particles of the Present Embodiment

The alloy fine particles of the present embodiment can be produced by a very simple technique of mixing a highly volatile alcohol (for example, ethanol), a noble metal salt, and a base metal salt, and heat-treating the mixture, and can also be produced by an environment-friendly production method which does not generate any waste liquid in the producing process.

Since the alloy fine particles of the present embodiment have an average particle diameter of 0.7 nm or more and less than 2 nm, the metal utilization rate is high at the atomic level, and high performance is achieved. Therefore, for example, the alloy fine particles are suitable, for example, for an electrode catalyst for a polymer electrolyte fuel cell used as a power source for households or automobiles for which reduction in the amount of noble metal used is required.

### 11. Electrode

The electrode containing the alloy fine particles may be used as a cathode, as an anode, or both as a cathode and as an anode.

### 12. Fuel Cell

The fuel cell contains the alloy fine particles. Examples of the fuel cell can include a polymer electrolyte fuel cell (PEFC), a phosphoric acid fuel cell (PAFC), a molten carbonate fuel cell (MCFC), a solid oxide fuel cell (SOFC), an alkaline electrolyte fuel cell (AFC), and a direct fuel cell (DFC).

### 13. Configuration Example of Fuel Cell

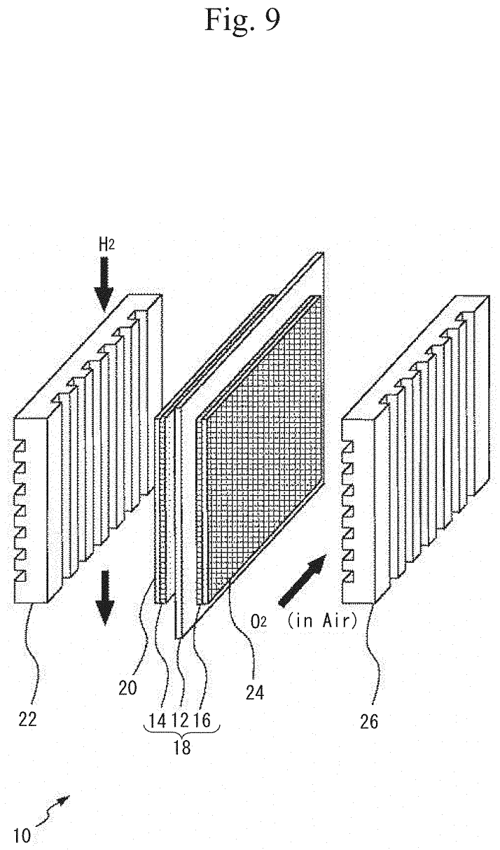

A configuration example of the fuel cell will be described. This fuel cell 10 is a polymer electrolyte fuel cell as a suitable example. As shown in FIG. 9, the fuel cell 10 includes a polymer electrolyte membrane 12 as an electrolyte membrane. The polymer electrolyte membrane 12 is made of, for example, a perfluorosulfonic acid resin. On both sides of the polymer electrolyte membrane 12, an anode electrode 14 and a cathode electrode 16 are provided so as to sandwich the polymer electrolyte membrane 12. The polymer electrolyte membrane 12 and a pair of the anode electrode 14 and the cathode electrode 16 sandwiching the polymer electrolyte membrane 12 constitute a membrane electrode assembly 18.

A gas diffusion layer 20 is provided outside the anode electrode 14. The gas diffusion layer 20 is made of a porous material such as carbon paper, carbon cloth, or a metal porous body, and has a function of uniformly diffusing a gas supplied from a separator 22 side into the anode electrode 14. Similarly, a gas diffusion layer 24 is provided outside the cathode electrode 16. The gas diffusion layer 24 has a function of uniformly diffusing a gas supplied from a separator 26 side into the cathode electrode 16. Although the figure shows only one set of the membrane electrode assembly 18, the gas diffusion layers 20 and 24, and the separators 22 and 26 configured as described above, the actual fuel cell 10 may have a stack structure in which a plurality of membrane electrode assemblies 18 and gas diffusion layers 20 and 24 are stacked with the separators 22 and 26 interposed therebetween.

### 14. Method for Producing Membrane Electrode Assembly 18

A method for producing the membrane electrode assembly 18 includes a step of spraying a mixture obtained by mixing a noble metal salt, a base metal salt, at least one solvent selected from alcohols having 1 or more and 5 or less carbon atoms, and a support onto the polymer electrolyte membrane 12 and drying the mixture to form alloy fine particles containing a noble metal, thereby forming an electrode containing the alloy fine particles on a surface of the polymer electrolyte membrane 12. In this production method, at least one of the anode electrode 14 and the cathode electrode 16 may be formed by spray-drying the mixture. The other of the anode electrode 14 and the cathode electrode 16 may be formed by another method. Of course, both the anode electrode 14 and the cathode electrode 16 may be formed by spraying and drying the mixture.

The above descriptions of “(1) Alloy fine particles”, “(2) Noble metal salt”, “(3) Base metal salt”, “(4) Alcohol having 1 to 5 carbon atoms”, “(5) Support”, “(6) Mixing ratio of support to alcohol”, “(7) Mixing”, “(8) Heating”, “(9) Average particle diameter of alloy fine particles”, and “(10) Effect of production method of the present embodiment” described in the section “1. Methods for producing alloy fine particle-supported catalyst” are applied to the method for producing the membrane electrode assembly 18 of the present disclosure as they are, and these descriptions are omitted.

A spraying method is not particularly limited. The spraying is performed using, for example, a spray nozzle. A temperature of the mixture to be sprayed is not particularly limited. The temperature of the mixture is, for example, 10° C. or higher and 40° C. or lower from the viewpoint of maintaining the state of the substance. By spraying the mixture into the atmosphere, alloy fine particles (alloy nanoparticles) are formed. An ambient temperature during the spraying is not particularly limited. The ambient temperature is preferably 10° C. or higher and 300° C. or lower, more preferably 15° C. or higher and 150° C. or lower, and further preferably 20° C. or higher and 100° C. or lower from the viewpoint of drying the mixture to form alloy fine particles. A pressure of the atmosphere may be any of normal pressure (atmospheric pressure), reduced pressure, and increased pressure.

The atmosphere is preferably a gas atmosphere containing oxygen in an amount of 0 ppm or more and 50,000 ppm or less. In a gas atmosphere having a low oxygen concentration, an unintended oxidation reaction is suppressed. Examples of the unintended oxidation reaction include an oxidation reaction in which, when a support is contained in the mixture, the support is oxidized by oxygen. Specifically, the following oxidation reaction is suppressed. When a noble metal salt is used as the metal salt, alloy fine particles containing a noble metal are formed on the support. At this time, when oxygen is present, the alloy fine particles function as a catalyst, so that the support is oxidized. Therefore, in order to suppress such an oxidation reaction, a gas atmosphere having a low oxygen concentration is preferable.

The spraying is preferably performed toward a target from the viewpoint of efficiently collecting the alloy fine particles. The target functions as a trapping material that traps the alloy fine particles. As the target, for example, a plate-shaped member is suitably used. As the plate-shaped member, a fluororesin plate is suitably used. The target may be heated. For the heating, for example, a heater is used. A heating temperature for heating the target is not particularly limited. The heating temperature is, for example, 30° C. or higher and 100° C. or lower.

### 15. Method for Producing Fuel Cell 10

A method for producing the fuel cell 10 relates to the fuel cell 10 including the membrane electrode assembly 18 having the polymer electrolyte membrane 12, the anode electrode 14, and the cathode electrode 16. This production method includes a step of spraying a mixture obtained by mixing a noble metal salt, a base metal salt, at least one solvent selected from alcohols having 1 or more and 5 or less carbon atoms, and a support onto the polymer electrolyte membrane 12 and drying the mixture to form alloy fine particles containing a noble metal, thereby forming an electrode containing the alloy fine particles on a surface of the polymer electrolyte membrane 12.

In this production method, at least one of the anode electrode 14 and the cathode electrode 16 may be formed by spraying and drying the mixture. The other of the anode electrode 14 and the cathode electrode 16 may be formed by another method. Of course, both the anode electrode 14 and the cathode electrode 16 may be formed by spraying and drying the mixture.

The above descriptions of “(1) Alloy fine particles”, “(2) Noble metal salt”, “(3) Base metal salt”, “(4) Alcohol having 1 to 5 carbon atoms”, “(5) Support”, “(6) Mixing ratio of support to alcohol”, “(7) Mixing”, “(8) Heating”, “(9) Average particle diameter of alloy fine particles”, and “(10) Effect of production method of the present embodiment” described in the section “1. Methods for producing alloy fine particle-supported catalyst” are applied to the method for producing the fuel cell 10 of the present disclosure as they are, and these descriptions are omitted. With regard to the spraying, the description in the section “14. Method for producing membrane electrode assembly 18” is applied as it is, and this description is omitted.

### EXAMPLES

The present disclosure will be described more specifically by way of Examples.

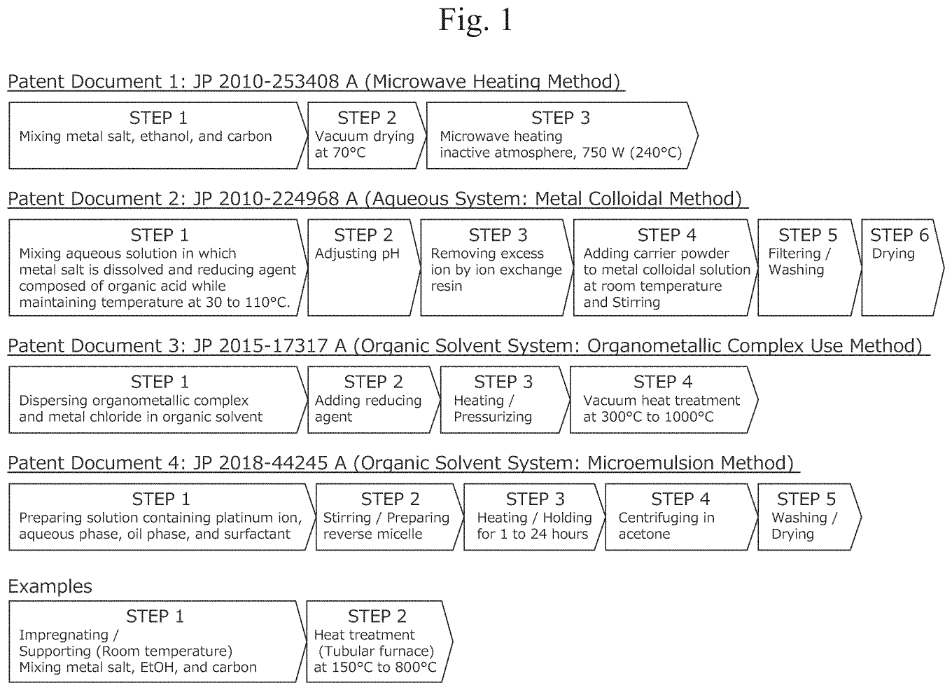

FIG. 1 shows a comparison between the number of steps in Examples and the number of steps in each of the patent documents. It can be seen that the Examples have the smallest number of steps. Another feature is that the production method of the Examples is an environment-friendly production method that does not generate any waste liquid because it does not use any organic substance or aqueous solution other than a volatile alcohol in the producing process.

### 1. Example 1

In Example 1, the influences of the Co salt type and the metal composition on the formation of Pt—Co (platinum-cobalt) alloy nanoparticles was examined. The alloy nanoparticles correspond to the “alloy fine particles” of the present disclosure.

As shown in Table 1, a Pt salt and a Co salt were collected in a beaker, ethanol (C₂H₅OH) was added thereto, and the Pt salt and Co salt were dissolved therein so that the mixture should have a predetermined metal salt concentration. After collection of graphitized carbon black (GCB, specific surface area of 150 m² g⁻¹: LION) in a mortar, an ethanol solution in which the above Pt salt and Co salt were dissolved was added thereto, and the mixture was stirred and mixed until ethanol volatilized to dryness. The obtained powder was transferred to a ceramic boat and heat-treated in an argon (Ar) atmosphere at 200° C. for 2 hours in a tubular furnace. After the temperature was lowered to room temperature, the heat-treated powder was taken out from the tubular furnace and evaluated as a catalyst.

As a Pt salt raw material, hexachloroplatinum (IV) acid hexahydrate (H₂PtCl₆.6H₂O) was used. As a Co salt raw material, [1] cobalt (II) chloride hexahydrate (CoCl₂.6H₂O) or [2] cobalt (II) nitrate hexahydrate (Co(NO₃)₂.6H₂O) was used. Adjustment was performed to form PtₓCo/C (X=3 or 1, atom ratio) as an alloy.

TABLE 1
Physical property value of PtₓCo/C (X = 3 or 1)
(comparison between charge value and analysis value)

Hexachloroplatinum

| (IV) acid | | | | | | | |
|---|---|---|---|---|---|---|---|
| hexahydrate | | | | | Metal salt | | Particle |
| (H₂PtCl₆•6H₂O) | Amount supported | | Composition Pt:Co | | concentration | | diameter |
| Cobalt (II) chloride | (mass %) | | (atom %) by EDX | | (mol L⁻¹) | | (nm) by TEM |
| hexahydrate | Charge | Analysis | Charge | Analysis | Pt | Co | Analysis |
| (CoCl₂•6H₂O) | value | value | value | value | salt | salt | value |
| Pt₃Co/C | 30 | 27 | 75:25 | 74:26 | 37 | 13 | 1.1 ± 0.2 |
| PtCo/C | 30 | 29 | 50:50 | 52:48 | 25 | 25 | 1.1 ± 0.2 |
| Pt₃Co/C | 30 | 29 | 75:25 | 77:23 | 37 | 13 | 1.1 ± 0.2 |
| PtCo/C | 30 | 30 | 50:50 | 50:50 | 25 | 25 | 1.1 ± 0.2 |

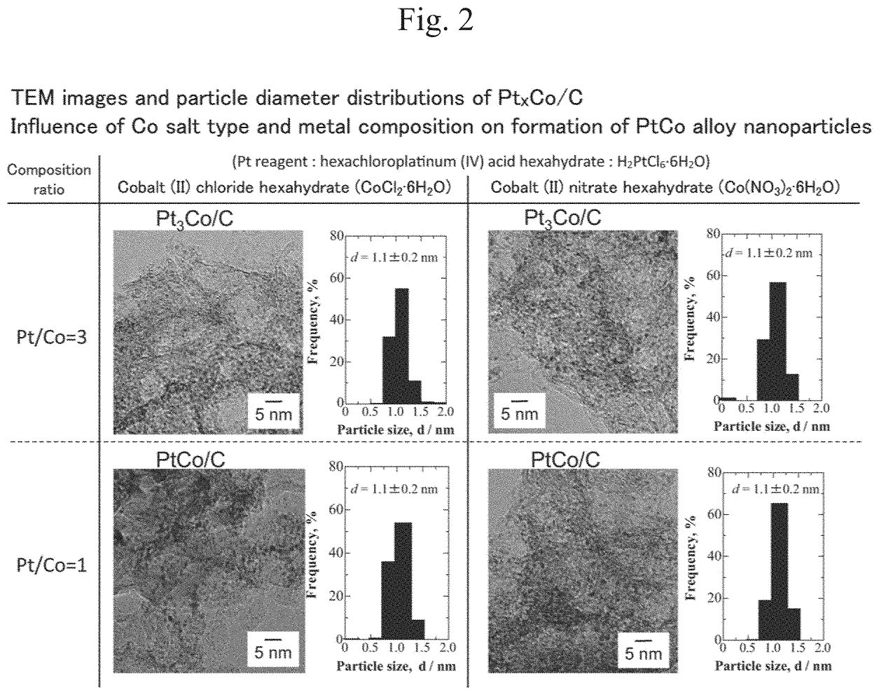

Transmission electron microscope (TEM) images and particle diameter distributions are shown in FIG. 2. Focusing on Pt₃Co/C prepared with each Co salt, it can be confirmed that alloy nanoparticles (black dots) of Pt₃Co are supported, in a highly dispersed manner, on a carbon (light gray portion in each image) support. Both of their distribution widths were narrow, and both were equal in the average particle diameter and the standard deviation value of the particle diameter, i.e., d=1.1±0.2 nm. Also in the PtCo/C cases, it was found that the particle diameter was similarly controlled without being affected by the Co salt type. Here, the particle diameter has a correlation (linear relationship) with the metal salt concentration (total concentration) at the time of synthesis, and can be easily controlled. The total concentration is preferably set to 2 mol L⁻¹ or more and 50 mol L⁻¹ or less. For both Pt₃Co/C and PtCo/C shown in FIG. 2, the metal salt concentration (total concentration of H₂PtCl.6H₂O and the Co salt) was adjusted to 50 mol L⁻¹. From the fact that the average particle diameters of all the four catalysts shown in FIG. 2 were the same, it was proved that the particle size can be precisely controlled by the metal salt concentration in the Pt alloy.

Table 1 summarizes physical property values (charge value and analysis value) of each catalyst. As for the amount of the metal supported (in the table, simply referred to as “amount supported”), the charge value at the time of synthesis was set to 30 mass % (wt %) for all the four catalysts. The analysis value after synthesis was 27 to 30 mass % (wt %) for the four catalysts. As described above, the charge value and the analysis value were substantially the same. That is, it was found that the metal can be reduced almost without loss at the synthesis stage, and that the supporting rate can also be arbitrarily controlled. Next, focusing on the composition, it was found that, at least in the case of Co within the range of 25 to 50 atom %, an alloy having almost the same composition as the charge value can be prepared. As described above, the particle size can be controlled with d=1.1 nm in all the four catalysts. Thus, it was found that the technique of the present disclosure can arbitrarily control all of the three factors, i.e., the amount of the metal supported, the metal composition, and the particle diameter.

### 2. Example 2

In Example 2, Pt—V (platinum-vanadium) alloy nanoparticles were examined.

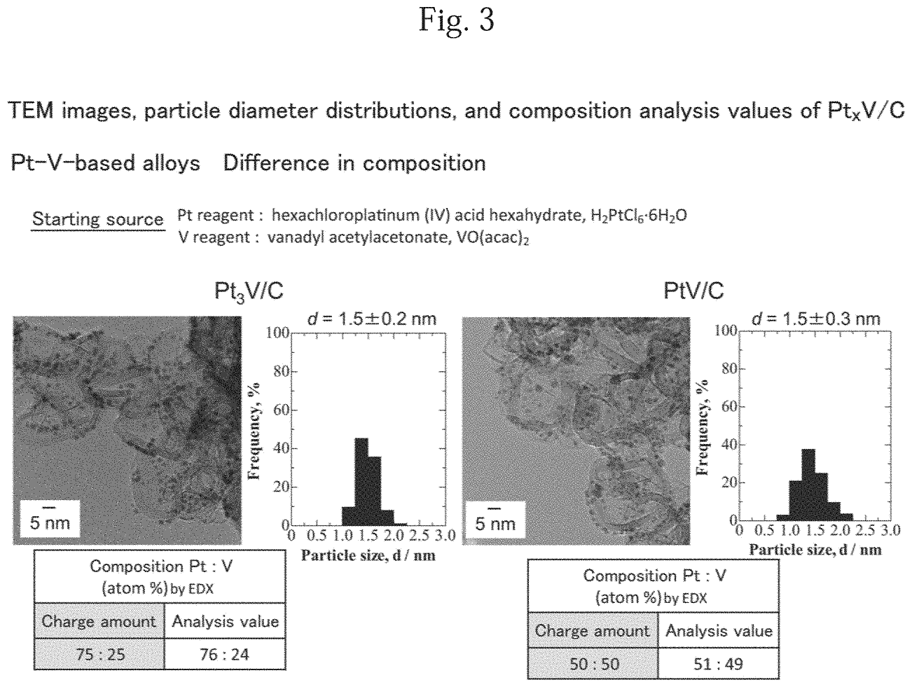

Pt_{X}V/C (X=3 or 1, atom ratio) was prepared in the same manner as in Example 1, using hexachloroplatinum (IV) acid hexahydrate (H₂PtCl.6H₂O) as a Pt salt raw material and vanadyl acetylacetonate (VO(acac)₂) as a V salt. FIG. 3 shows TEM images, particle diameter distributions, and composition analysis values of Pt_{X}V/C. Even when the second component was vanadium, it was confirmed that PtV alloy nanoparticles were formed (black dots) regardless of the composition, and were supported, in a highly dispersed manner, on carbon. The particle size was also equivalent to that in Example 1, and, also as for the composition, it was found that an alloy was formed of the components with the intended composition.

### 3. Example 3

In Example 3, Pt—Ni (platinum-nickel) alloy nanoparticles were examined.

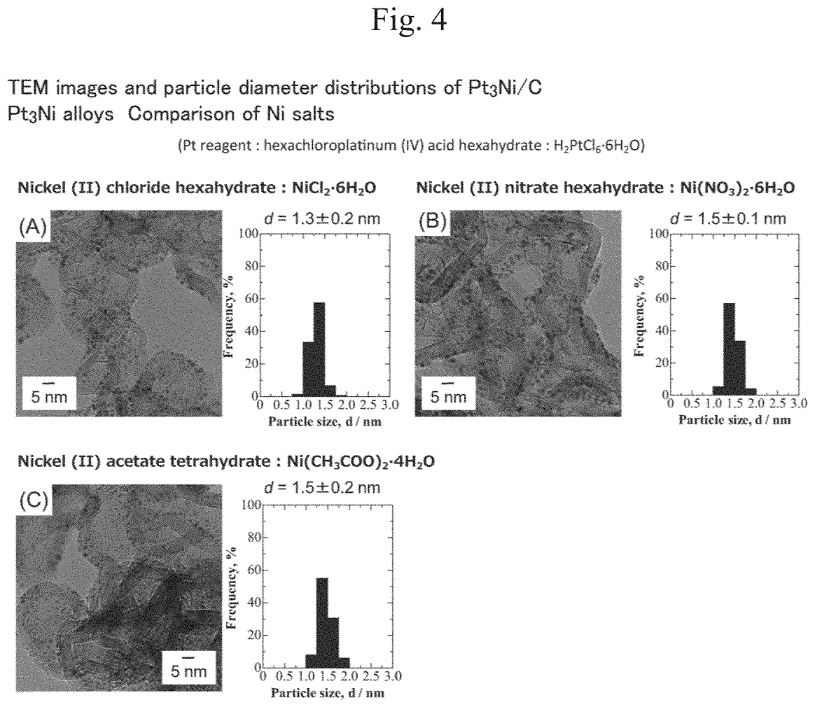

As a Pt salt raw material, hexachloroplatinum (IV) acid hexahydrate (H₂PtCl₆.6H₂O) was used. As an Ni salt material, [1] nickel (II) chloride hexahydrate (NiCl₂.6H₂O), [2] nickel (II) nitrate hexahydrate: (Ni(NO₃)₂.6H₂O), or [3] nickel (II) acetate tetrahydrate (Ni(CH₃COO)₂.4H₂O) was used to prepare Pt₃Ni/C. In all the cases, the metal composition is Pt/Ni=3/1. As shown in FIG. 4, also in the Pt—Ni alloy cases, regardless of the Ni salt type, alloy nanoparticles having a narrow particle diameter distribution and an average particle diameter of about 1.5 nm were supported, in a highly dispersed manner, in all Pt₃Ni/C.

### 4. Summary of Examples 1 to 3

From the results of Examples 1 to 3, it was confirmed that the use of a metal salt soluble in a lower alcohol (alcohol having 1 to 5 carbon atoms) can form alloy nanoparticles regardless of the type of the second element.

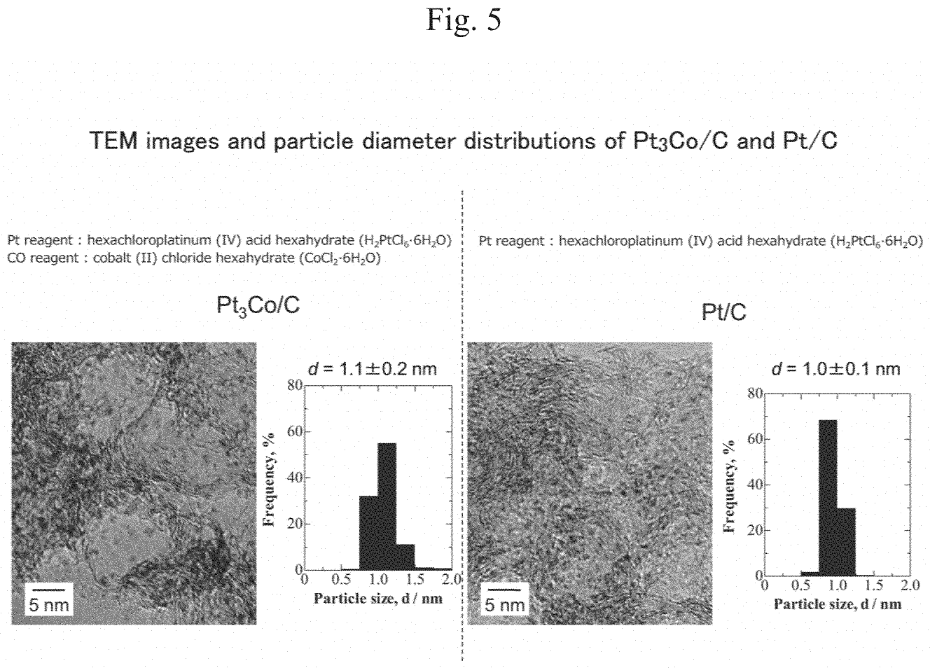

For reference, FIG. 5 shows Pt₃Co alloy nanoparticles of Experiment 1 and Pt nanoparticles formed of Pt alone in comparison with each other. In the case of the Pt nanoparticles formed of Pt alone, an experiment was performed according to Example 1. It was found that the alloy nanoparticles were supported on the support while maintaining the degree of dispersion and particle diameter distribution width which were the same as those in the case of the Pt nanoparticles formed of Pt alone.

For each of the alloy nanoparticles, the particle diameter distribution (average particle diameter and standard deviation of particle diameter distribution) was determined as follows. That is, the synthesized alloy nanoparticles were observed by a transmission electron microscope (TEM). A TEM photograph was printed out on paper. The alloy nanoparticles (black circular images) were regarded as spherical, and the length from end to end of each of the alloy nanoparticles was regarded as diameter. A total of 300 particles were randomly measured from images of several fields of view (3 to 5 fields of view). A value obtained by averaging the diameters of the counted 300 particles was defined as average particle diameter. In addition, a distribution map was created from the particle diameters of the 300 particles to calculate the standard deviation value. The distribution width of the particle diameter of each of the synthesized alloy nanoparticles was very narrow, and the standard deviation value was between 0 and 20% of the average particle diameter value.

### 5. Comparison in Catalytic Activity (Oxygen Reduction Reaction Activity)

In order to examine the catalytic activity of the catalyst prepared in Example 1, the oxygen reduction reaction activity in a 0.1 M perchloric acid solution was examined by the rotating ring disk electrode (RRDE) method. Hereinafter, the results of Pt₃Co/C will be described as a typical example. In addition, as a comparison, a Pt-alone catalyst (Pt/C) prepared by the same method and a commercially available Pt standard catalyst (commercially available standard Pt/C) were similarly examined.

FIG. 5 shows TEM images and particle diameter distributions of Pt₃Co/C and Pt/C for which the ORR activity was comparatively evaluated. Both the nanoparticles were supported, in a highly dispersed manner, on the support. The average particle diameters of Pt₃Co/C and Pt/C were d=1.1 nm and d=1.0 nm, respectively, and it was confirmed that they were equivalent catalysts. The particle diameter distribution widths of both the catalysts were narrow, and it was found that the catalysts were different only in the metal component (alloy or Pt-alone).

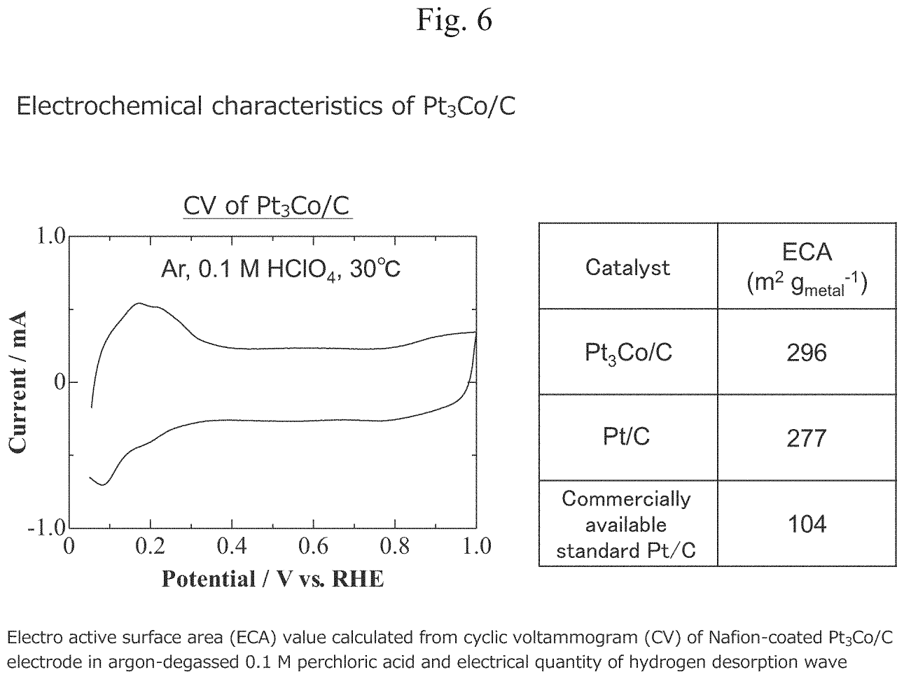

Pt₃Co/C was fixed on a carbon substrate serving as a working electrode to form an electrode, and a cyclic voltammogram (CV) was measured in a 0.1 M HClO₄ solution. The results are shown in FIG. 6. In FIG. 6, an electro active specific surface area (ECA) calculated from the hydrogen adsorption wave of CV of each catalyst is also shown. The CV waveform of Pt₃Co/C was similar to the CV waveform of pure Pt/C, and a desorption wave of hydrogen could be observed on the low potential side (0.05 V to 0.35 V), and an oxidation-reduction wave of Pt could be observed on the high potential side (0.8 V to 1.0 V). An electrical quantity was determined from the desorption wave of hydrogen, and an actual surface area (cm²) was calculated. The actual surface area was divided by an amount (g) of metal fixed for forming an electrode, so that the electro active specific surface area (ECA) was determined. It was found that the ECA value depends on the radius of the nanoparticles, and that the ECA values of the three catalysts correspond to the specific surface areas determined from the particle sizes.

### 6. Activity of Oxygen Reduction Reaction (ORR)

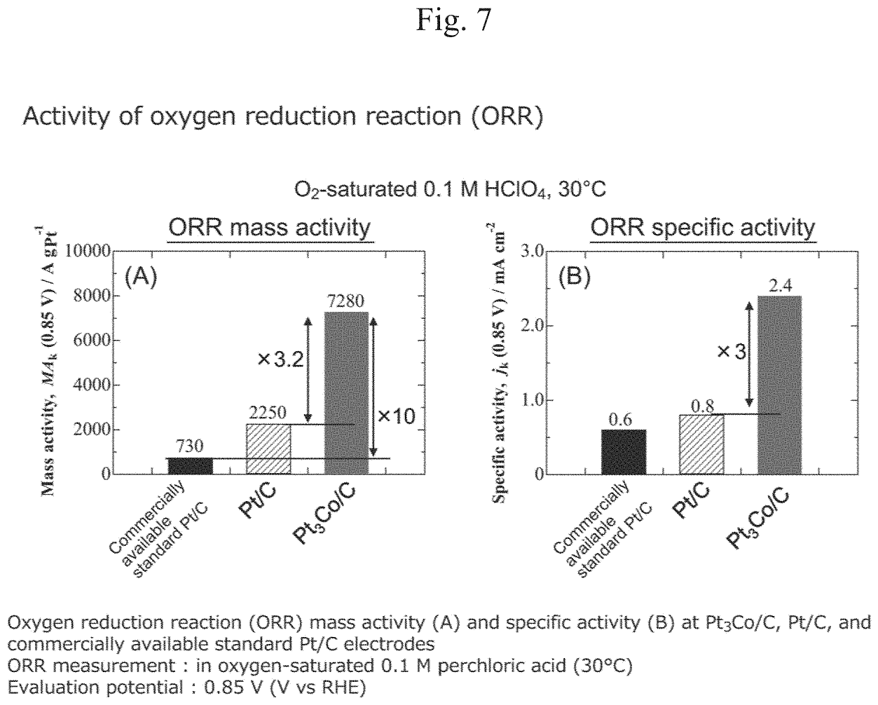

FIG. 7 shows the results of mass activity and specific activity of the oxygen reduction reaction (ORR) measured in oxygen-saturated 0.1 M HClO₄ (30° C.). A commercially available standard Pt/C catalyst (d=3 nm for Pt nanoparticles), a Pt/C catalyst (d=1 nm for Pt nanoparticles), and a Pt₃Co/C catalyst are comparatively studied.

Attention is first focused on the mass activity (left figure in FIG. 7). It is found that the Pt/C catalyst (d=1 nm) has higher activity than the commercially available standard Pt/C catalyst (d=3 nm). This is because the specific surface area associated with the particle size influences the activity. However, when looking at the specific activity (right figure in FIG. 7), it can be seen that the commercially available standard Pt/C catalyst (d=3 nm) and the Pt/C catalyst (d=1 nm) are comparable.

On the other hand, the mass activity of the Pt₃Co/C catalyst is about three times higher than the mass activity of the Pt/C catalyst (d=1 nm). The specific activity of the Pt₃Co/C catalyst is also about three times higher than the specific activity of the Pt/C catalyst (d=1 nm). From this result, it can be seen that the effect obtained by alloying, that is, the effect that Pt on the surfaces of the particles is subjected to the electron modification effect through alloying so that oxygen is easily adsorbed is exhibited. Furthermore, in combination with a specific surface area effect, the Pt₃Co/C catalyst is estimated to have a 10-fold increase in mass activity over the commercially available standard Pt/C catalyst.

### 7. H₂O₂ Generation Rate

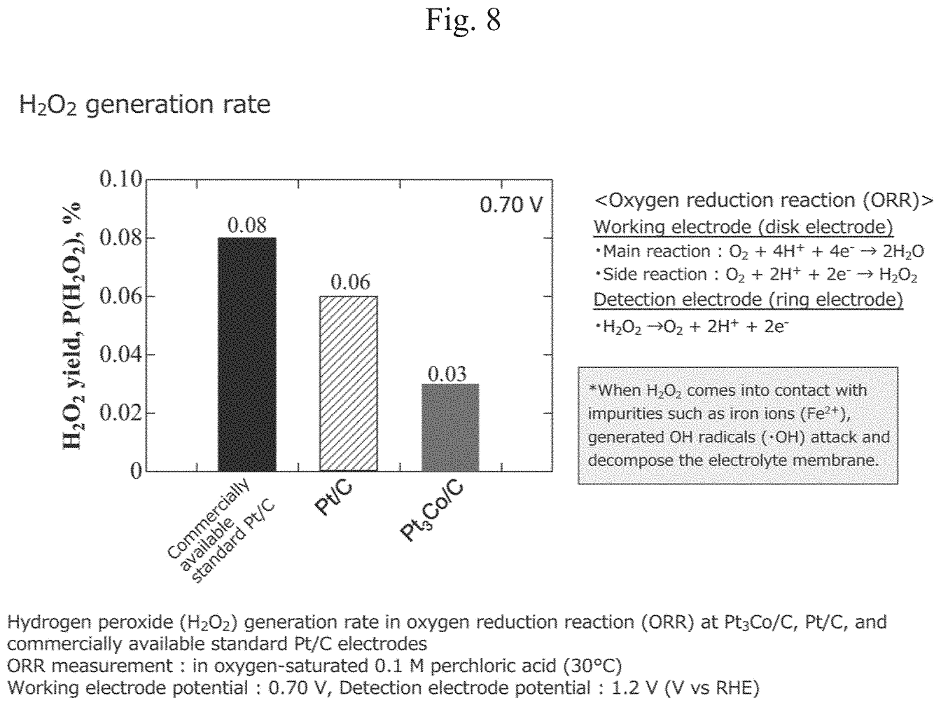

FIG. 8 shows results of examining a proportion of generation of hydrogen peroxide (H₂O₂), which is a side reaction occurring in the oxygen reduction reaction. A commercially available standard Pt/C catalyst (d=3 nm for Pt nanoparticles), a Pt/C catalyst (d=1 nm for Pt nanoparticles), and a Pt₃Co/C catalyst are comparatively studied. As described in FIG. 8, in the oxygen reduction reaction, water is produced by four-electron reduction as a main reaction, and H₂O₂ is generated by two-electron reduction as a side reaction. This H₂O₂, when generated inside the polymer electrolyte fuel cell, becomes a factor that deteriorates the electrolyte membrane, and thus a catalyst that suppresses the generation thereof as much as possible is required. Referring to FIG. 8, it was found that the H₂O₂ generation rate of the Pt₃Co/C catalyst can be suppressed to half or less relative to those of the Pt catalyst (commercially available standard Pt/C catalyst (d=3 nm for Pt nanoparticles) and the Pt/C catalyst (d=1 nm for Pt nanoparticles)).

### 8. Effect of Examples

The use of an alloy of a noble metal and a base metal (non-noble metal) as the catalyst can reduce the amount of the noble metal used. For example, when the composition ratio (atom %) of noble metal to base metal is 50:50, the mass of Pt constituting the nanoparticles can be reduced to about 70% in some cases. Moreover, in the Examples, the activity as a fuel cell catalyst can be increased, and thus it is suggested that the amount of Pt used may be significantly reduced as compared with the current amount of Pt used. Since the activity can be increased up to 10 times higher than the conventional activity, the amount of Pt used may be reduced to 1/10 or less of the current amount of Pt used. Therefore, the Examples are highly effective in terms of cost reduction and resource saving. Furthermore, in the Examples, the lifetime of the system can be extended by suppressing the generation of H₂O₂ which is a factor for cell deterioration. In addition, the Examples are clean to the environment. Thus, according to the Examples, it is expected to accelerate the spread of fuel cells themselves, and it is also greatly expected to accelerate the spread of fuel cell automobiles and stationary cogeneration using fuel cells.

It is noted that the foregoing examples have been provided merely for the purpose of explanation and are in no way to be construed as limiting of the present disclosure. While the present disclosure has been described with reference to exemplary embodiments, it is understood that the words which have been used herein are words of description and illustration, rather than words of limitation. Changes may be made, within the scope of the appended claims, without departing from the scope and spirit of the present disclosure in its aspects. Although the present disclosure has been described herein with reference to particular structures, materials and embodiments, the present disclosure is not intended to be limited to the particulars disclosed herein; rather, the present disclosure extends to all functionally equivalent structures, methods and uses, which are within the scope of the appended claims.

The present disclosure is not limited to the embodiments described in detail above, and can be modified or changed in various manners within the scope as set forth in the claims of the present disclosure.

1. A method for producing an alloy fine particle-supported catalyst that supports alloy fine particles containing a noble metal, the method comprising:
mixing a noble metal salt, a base metal salt, an alcohol having 1 to 5 carbon atoms, and a support to form a mixture; and
heating the mixture at a temperature of 150° C. or higher and 800° C. or lower to produce an alloy fine particle-supported catalyst.

2. The method for producing an alloy fine particle-supported catalyst according to claim 1, wherein a total concentration of the noble metal salt and the base metal salt in an alcohol solution in which the noble metal salt and the base metal salt are dissolved is 2 mol L⁻¹ or more and 100 mol L⁻¹ or less.

3. The method for producing an alloy fine particle-supported catalyst according to claim 1, wherein an average particle diameter of the alloy fine particles is 0.7 nm or more and less than 2 nm.

4. An electrode comprising the alloy fine particle-supported catalyst produced by the production method according to claim 1.

5. A fuel cell comprising the alloy fine particle-supported catalyst produced by the production method according to claim 1.

6. A method for producing alloy fine particles, comprising:
mixing a noble metal salt, a base metal salt, and an alcohol having 1 to 5 carbon atoms to form a mixture; and
heating the mixture at a temperature of 150° C. or higher and 800° C. or lower to produce alloy fine particles containing a noble metal.

7. The method for producing alloy fine particles according to claim 6, wherein a total concentration of the noble metal salt and the base metal salt in an alcohol solution in which the noble metal salt and the base metal salt are dissolved is 2 mol L⁻¹ or more and 100 mol L⁻¹ or less.

8. The method for producing alloy fine particles according to claim 6, wherein an average particle diameter of the alloy fine particles is 0.7 nm or more and less than 2 nm.

9. An electrode comprising the alloy fine particles produced by the production method according to claim 6.

10. A fuel cell comprising the alloy fine particles produced by the production method according to claim 6.

11. An alloy fine particle-supported catalyst in which alloy fine particles containing a noble metal are supported on a support,
wherein an average particle diameter of the alloy fine particles is 0.7 nm or more and less than 2 nm.

12. An electrode comprising the alloy fine particle-supported catalyst according to claim 11.

13. A fuel cell comprising the alloy fine particle-supported catalyst according to claim 11.

14. An alloy fine particle having an average particle diameter of 0.7 nm or more and less than 2 nm and containing a noble metal.

15. An electrode comprising the alloy fine particles according to claim 14.

16. A fuel cell comprising the alloy fine particles according to claim 14.

17. A method for producing a membrane electrode assembly having an electrolyte membrane and an electrode, the method comprising:
spraying a mixture obtained by mixing a noble metal salt, a base metal salt, at least one solvent selected from alcohols having 1 or more and 5 or less carbon atoms, and a support onto the electrolyte membrane and drying the mixture to form alloy fine particles containing a noble metal, thereby forming the electrode comprising the alloy fine particles on a surface of the electrolyte membrane.

18. A method for producing a fuel cell containing a membrane electrode assembly having an electrolyte membrane and an electrode, the method comprising:
spraying a mixture obtained by mixing a noble metal salt, a base metal salt, at least one solvent selected from alcohols having 1 or more and 5 or less carbon atoms, and a support onto the electrolyte membrane and drying the mixture to form alloy fine particles containing a noble metal, thereby forming the electrode comprising the alloy fine particles on a surface of the electrolyte membrane.
